(19) United States
(12) Patent Application Publication
(10) Pub. No.: US 2018/0239134 A1
(43) Pub. Date: Aug. 23, 2018

(54) PROJECTION DISPLAY SYSTEM

(71) Applicant: Gentex Corporation, Zeeland, MI (US)

(72) Inventors: Sue F. Franz, Holland, MI (US); Neil J. Boehm, Allegan, MI (US)

(21) Appl. No.: 15/901,527

(22) Filed: Feb. 21, 2018

Related U.S. Application Data
(60) Provisional application No. 62/461,395, filed on Feb. 21, 2017.

(51) Int. Cl. G02B 27/01; G03B 21/20; B60R 11/02; B60K 37/02

(52) U.S. Cl. CPC G02B 27/0101; G03B 21/2013; G03B 21/2033; G01C 9/02; G03B 21/2066; B60R 11/0229; B60K 37/02; G03B 21/208

(57) ABSTRACT

A vehicle projection display system including a transparency, a rearview display, a display aid layer positioned on the transparency and a projector coupled to the rearview display and configured to project light onto the display aid layer. The display aid layer is configured to scatter the light to form a projected image on the display aid layer.

### CROSS-REFERENCE TO RELATED APPLICATION

This application claims the benefit of and priority to U.S. Provisional Patent Application No. 62/461,395, filed on Feb. 21, 2017, entitled HEADS-UP DISPLAY SYSTEM, the entire disclosure of which is hereby incorporated herein by reference.

### FIELD OF THE DISCLOSURE

The present disclosure generally relates to a display system, and more particularly, to a projection display system.

### BACKGROUND

Projection displays systems may provide information overlaid on ambient light transmitted through transparencies. Accordingly, such projection systems may be advantageous.

### SUMMARY OF THE DISCLOSURE

According to at least one feature of the present disclosure, a vehicle projection display system includes a transparency, a rearview display, a display aid layer positioned on the transparency and a projector coupled to the rearview display and configured to project light onto the display aid layer. The display aid layer is configured to scatter the light to form a projected image on the display aid layer.

According to at least one feature of the present disclosure, a vehicle projection display system includes a transparency, a display aid layer positioned on a surface of the transparency and a projector positioned to project light onto the display aid layer. The display aid layer is configured to scatter light to form a projected image on the display aid layer.

According to at least one feature of the present disclosure, a vehicle projection display system includes a screen, a display aid layer positioned on a surface of the screen. The display aid layer includes a plurality of resonant nanoparticles. A projector positioned to project laser light onto the display aid layer, wherein the display aid layer is configured to scatter the laser light to form a projected image on the display aid layer.

These and other features, advantages, and objects of the present disclosure will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1A is a front elevational view of a vehicle interior, according to at least one example;

FIG. 1B is a front elevational view of the vehicle interior, according to at least one example;

FIG. 2A is a cross-sectional view of a projector, according to at least one example; and

FIG. 2B is a cross-sectional view of a projector, according to at least one example.

### DETAILED DESCRIPTION

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

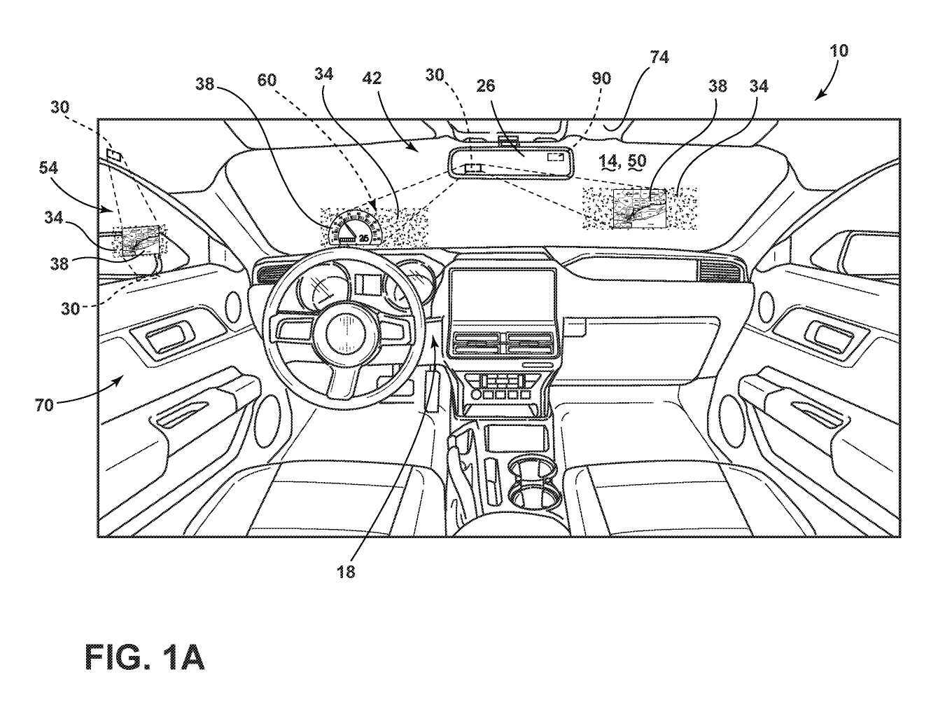

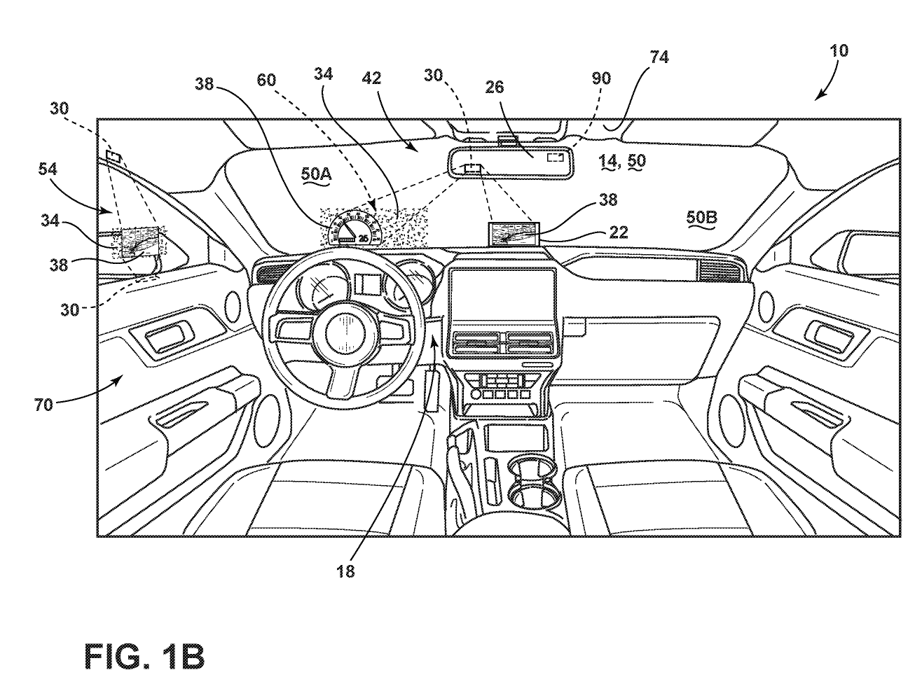

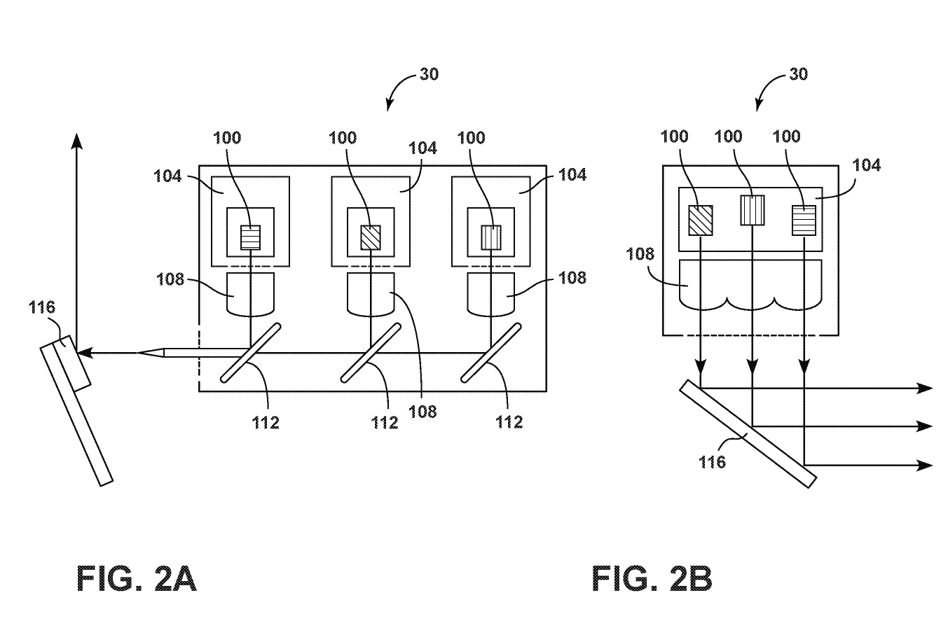

With regard to FIGS. 1A-2B, reference numeral 10 generally designates a vehicle 10 including a transparency 14. An instrument panel 18 is positioned at a vehicle forward portion of the vehicle 10. According to various examples, the instrument panel 18 may include a screen 22. According to various examples, a rearview display 26 is positioned vehicle rearward of the transparency 14. A projector 30 is coupled with the rearview display 26. The projector 30 is configured to project, or emit, light onto a display aid layer 34 which scatters the light to form an image 38 on the display aid layer 34 and/or transparency 14. The transparency 14, screen 22, projector 30 and display aid layer 34 may be part of a projection display system 42.

With respect to FIG. 1A, the projection display system 42 is depicted within the vehicle 10, but it will be understood that the projection display system 42 may equally be used within aerospace applications, window applications, transparency applications, augmented reality applications and other applications where a viewer may wish to see both information (e.g., vehicle-related functions or driver assistance systems such as alerts, warnings or vehicle diagnostics) and what is beyond the transparency 14. In the depicted example, the speed of the vehicle 10 is being displayed as the image 38 using an image of a speedometer. It will be understood that although described as projected on, or displayed on, the image 38 from the projector 30 is scattered by the transparency 14 and/or display aid layer 34 such that the image 38 appears in plane with the transparency 14 and/or in a distance beyond the transparency 14 to a viewer of the projection display system 42.

The vehicle 10 may include a plurality of transparencies 14 positioned around the vehicle 10. For example, the transparency 14 may be a front or rear windscreen 50, a side window 54, an opera or quarter window, a moonroof, a sunroof and/or other transparencies 14 positioned around the vehicle 10. According to various examples, the windscreen 50 may have a driver-side portion 50A and a passenger-side portion 50B positioned proximate driver and passenger sides of the vehicle 10. The vehicle 10 may include two or more side windows 54 positioned around an interior of the vehicle 10.

According to various examples, the vehicle 10 may include one or more electro-optic elements 60 incorporated in the transparencies 14 and/or the display aid layers 34. The electro-optic elements 60 may be configured to have variable transmittance to light. Exemplary electro-optic elements 60 and their uses in conjunction with transparencies 14 are disclosed in U.S. patent application Ser. No. 15/192,325, entitled “HEADS UP DISPLAY SYSTEM,” the entire disclosure of which is hereby incorporated herein by reference. For example, the projector 30 may project the light onto one or more display aid layers 34 positioned on the electro-optic element 60 such that the image 38 is formed. Further, as the electro-optic element 60 may have a variable transmissivity to light, the electro-optic element 60 may function to increase a contrast of the image 38 scattered by the display aid layer 34.

According to various examples, the display aid layer 34 is configured to scatter light emitted from the projector 30 and falling on the display aid layer 34. The display aid layer 34 may be positioned on an interior surface (e.g., a surface proximate an interior cabin of the vehicle 10) of the transparency 14, an exterior surface (e.g., a surface in contact with an environment around the vehicle 10) of the transparency 14 and/or within the transparency 14. In examples where the display aid layer 34 is positioned within the transparency 14, the transparency 14 may be a laminated structure (e.g., two pieces of glass separated by a polymeric interlayer) and the display aid layer 34 may be positioned on any surface within the transparency 14. The display aid layer 34 may extend over a portion, a majority, substantially all or all of the transparency 14. According to various examples, a plurality of display aid layers 34 may be positioned on the transparency 14. For example, the display aid layer 34 may extend from the driver-side portion 50A (FIG. 1A) of the windscreen 50 to the passenger-side portion 50B of the windscreen 50 a single unitary structure and/or the driver-side portion 50A and the passenger-side portion 50B of the windscreen 50 may each include a separate display aid layer 34.

The display aid layer 34 may be composed a variety of materials configured to scatter the light or otherwise form the image 38 from the light emitted from the projector 30. For example, the display aid layer 34 may be composed of a plurality of resonant nanoparticles. The resonant nanoparticles may also be known as plasmonic particles or plasmonic-resonant particles. Resonant nanoparticles are particles whose electron density can couple with electromagnetic radiation of wavelengths that are far larger than the particle diameter due to the nature of a dielectric-metal interface between a medium which surrounds the particle (e.g., the transparency 14 and/or air) and the particles. Resonant nanoparticles may exhibit scattering, absorbance, and coupling properties based on their geometries and relative positions. According to various examples, the resonant nanoparticles may include at least one of silver, gold, copper, aluminum, lithium, tantalum and/or combinations thereof. Additionally or alternatively, the display aid layer 34 may include a fluorescent material and/or a diffusive material. In fluorescent material examples, the fluorescent material of the display aid layer 34 may be configured to absorb and be excited or charged by the light from the projector 30 and re-emit the light in a diffuse manner to form the image 38. As such, it may be said that the fluorescent material of the display aid layer 34 scatters the light from the projector 30 to form the image 38. In examples where the display aid layer 34 includes a diffusive material, the diffusive material may be configured to scatter the light emitted from the projector 30 in a diffuse manner. Exemplary diffusive materials may include ground glass, polymeric materials such as acrylic sheet, polycarbonate sheet, and polycarbonate and other materials which reflect light in a non-specular manner. It will be understood that diffusive material examples of the display aid layer 34 may include materials which, to some degree, may specularly reflect, but include a plurality of scattering sites configured to diffusely reflect the light from the projector 30.

According to various examples, the display aid layer 34 may be configured to only scatter wavelengths of light emitted from the projector 30. For example, the display aid layer 34 may contain materials which are translucent or otherwise non-scattering to ambient light wavelengths, but preferentially scatter specific wavelengths emitted from the projector 30. Such examples may be advantageous in laser examples of the projector as explained in greater detail below.

Referring now to FIG. 1B, the screen 22 is coupled to the instrument panel 18, but it will be understood that the screen 22 may be positioned in a variety of locations around the vehicle 10. For example, the screen 22 may be positioned on or in a headliner, A-pillar, B-pillar, door, seat, center console and/or trim components within the vehicle 10. According to various examples, the screen 22 may be operable between an undeployed position and a deployed position. For example, in the undeployed position, the screen 22 may be partially or fully concealed or hidden within its supporting structure. The screen 22 may be manually, mechanically and/or electrically actuated to the deployed position such that the screen 22 is capable of being seen by a viewer and receiving light from the projector 30.

The screen 22 may be transmissive, translucent and/or opaque to various wavelengths of light. According to various examples, the screen 22 is configured to scatter light emitted from the projector 30 to form the image 38. For example, the screen 22 may include the display aid layer 34. Additionally or alternatively, the screen 22 may itself be configured to scatter light from the projector 30 to form the image 38. For example, the screen 22 may include a diffusively reflecting surface (i.e., a roughened surface) configured to form the image 38.

Referring now to FIGS. 1A-2B, the projector 30 may be positioned in a variety of locations around the vehicle 10. In the depicted examples, the projector 30 may be coupled to the rearview display 26, to a door 70 below the side window 54 examples of the transparency 14, to a headliner 74 above the side window 54 examples of the transparency 14, as well as other locations around the vehicle 10 such as a seat, a center console, an A-pillar, a B-pillar, and/or trim components within the vehicle 10. It will be understood that the vehicle 10 may include a plurality of projectors 30 positioned in any of the above-noted locations or in a number of locations.

The projector 30 is configured to project or emit light toward the display aid layer 34 and/or screen 22 such that the light is scattered to form the image 38 on the transparency 14 and/or screen 22. In examples where the projector 30 is coupled to the rearview display 26, the projector 30 may be positioned on a driver-side portion of the display 26, a passenger-side portion of the display 26 or both. According to some examples, one side of the rearview display 26 may have more projectors 30 than the other. The projector(s) 30 may be positioned on a vehicle forward exterior surface of the rearview display 26, or may be positioned inside of a housing of the display 26. In examples where the projector(s) 30 are positioned inside of the rearview display 26, an aperture may allow light from the projector 30 to escape and contact the screen 22 and/or display aid layer 34. In yet other examples, the projector 30 may be positioned on a mount or coupling arm of the rearview display 26.

Each projector 30 may be configured to project or emit light toward a single location or a plurality of locations on the vehicle 10. For example, the projector 30, regardless of location, may emit light toward the driver-side portion 50A of the windscreen 50, the passenger-side portion 50B of the windscreen 50, the side window 54 examples of the transparency 14, the screen 22 or combinations thereof. The projected light may be different or may be the same based on where the light is projected. As such, the images 38 formed in the different locations may be different than one another or may be the same. According to various examples, the image 38 may extend across portions of both the driver-side 50A and passenger-side portion 50B of the windscreen 50. In examples utilizing multiple projectors 30, each projector 30 may project the light onto the transparencies 14 at different heights or locations.

One or more of transparencies 14, or any intervening layers or substrates, may be shaped such that a resultant scattered image “appears” to be beyond (i.e., further) than the scattering surface of the transparency 14. The exact surface contour of the transparency 14 or layers needed to attain this characteristic is a function of properties of the projector 30, the location of the projector 30 and the location of the viewer (e.g., the driver and/or passenger to which information is intended to be displayed).

According to various examples, the projector 30 may be configured to correct the projected image based on the orientation of projector 30 and/or the transparency 14. For example, the properties of the projector 30 may be selected so as to preserve the basic characteristics of the image 38 (i.e., straight lines remain straight, aspect ratios of images are preserved, etc.). The projector 30 may be calibrated based on a known location of the projector 30 relative to the transparency 14, or may utilize one or more sensors. In rearview display 26 examples of the projector 30 example, the rearview display 26 may incorporate one or more orientation sensors 90 for detecting the orientation of the display 26. The orientation sensors 90 may be positioned within the display 26, on a coupling arm of the display 26 or within a mount of the display 26. It will be understood that the orientation sensors 90 may be additionally or alternatively coupled to the projector 30. The orientation sensors 90 may detect the pitch and angle of the projector 30 relative to the transparency 14 and/or screen 22. According to various examples, the projector 30 is configured to alter a direction of the emitted light in response to the orientation sensor 90 detecting a change in orientation of the rearview display 26. In examples where the projector 30 may be moved further from and closer to the transparency 14 and/or screen 22, the distance of the projector 30 to the transparency 14 and/or screen 22 may also be determined by the orientation sensor 90. The projector 30, and/or a controller controlling the projector 30, may be able to utilize data from the orientation sensor 90 in real time to automatically adjust the projected light, and therefore the image 38, based on movements of the projector 30 (e.g., when a driver of the vehicle 10 adjusts the display 26 based on their viewing characteristics). Such an example may be advantageous in allowing occupants within the vehicle 10 to adjust projector 30, transparency 14 and/or screen 22 while maintaining the image 38 with no or minimal distortion.

The projector 30 may take a variety of configurations configured to emit light toward the transparency 14 and/or screen 22. The projector 30 is a light engine capable of producing unpolarized or polarized light including, but not limited to, certain liquid crystal displays (LCDs), laser diodes, digital light processing technologies and/or organic light emitting diodes (OLEDs). In polarized light examples of the projector 30, the polarized light emitted may have a horizontal or vertical polarization angle or variations therebetween. In some instances, the polarized light from the projector 30 may be circularly polarized. For example, circular polarization of the light may be achieved when linearly polarized light from the projector 30 passes through a quarter wave plate.

In a first example, the projector 30 may be a digital light processing projector. In such an example, the projector 30 may include a digital micromirror device (DMD). The projector 30 may be adapted to produce a color image, in which case the colors may be produced by using four individual light sources (e.g., red, green, blue, and white light emitting diodes (LEDs)). The LEDs may be used to produce primary display color beams which may later be mixed to provide different (e.g., secondary and tertiary) color beams. Each of the colored light beams may be mirrored and then refracted by a condenser lens so as to focus the different light beams on a focus plane (e.g., the transparency 14 and/or screen 22). By controlling the DMD to selectively mirror light from the light sources, the light may be scattered to form the image 38 on the transparency 14 and/or screen 22.

Referring now to FIGS. 2A and 2B, the projector 30 may utilize one or more laser diodes 100 as a light source. In such examples, the projector 30 may be known as a laser projector 30. In the depicted examples, the projector 30 includes three laser diodes 100 (e.g., red, blue and green diodes). The laser diodes 100 may be individually packaged (FIG. 2A) or commonly packaged (FIG. 2B) in a packaging 104. The laser diodes 100 are configured to emit light into a microlens 108. In the example depicted in FIG. 2A, each of the laser diodes 100 have a standalone microlens 108, and in the example depicted in FIG. 2B, each of the laser diodes 100 share a microlens 108. The microlenses 108 may be used to aid in shaping and directing the beams from the laser diodes 100. The microlenses 108 may be formed of a transparent or substantially transparent material.

Referring now to FIG. 2A, the projector 30 includes a plurality of mirrors 112. In the depicted example, each of the laser diodes 100 is configured to emit light towards one of the mirrors 112. One or more of the mirrors 112 may be a dichroic beam combiner configured to reflect a wavelength band of light and transmit a wavelength band (e.g., colors) of light. Use of the dichroic beam combiner examples of the mirrors 112 allows a beam from each of the laser diodes 100 to be coaxial with one another. Mixing of the beams into a single coaxial beam may allow color mixing to occur such that the coaxial beam has a color different than any one of the laser diodes 100 individually. The coaxial beam may then exit the projector 30 and contact a micro-electric mirror 116. The micro-electric mirror 116 may be actuated or moved to steer the coaxial beam from the laser diodes 100 toward the transparency 14 and/or screen 22 such that the light can be scattered to form the image 38. The micro-electric mirror 116 may raster back and forth to create the image 38. It will be understood that both examples of the projector 30 may be used without the micro-electric mirror 116 and that the projector 30 itself may be moved.

Referring now to the depicted example in FIG. 2B, the projector 30 may not include the separate mirrors 112 to create the coaxial beam, but rather emits each of the laser beams in a non-coaxial fashion toward the micro-electric mirror 116. In such an example, the micro-electric mirror 116 may cross the laser beams to achieve color mixing or each laser beam may have its own micro-electric mirror 116 such that steering of each beam of the laser diodes 100 beams may be achieved.

Use of examples for the projector 30 which use the laser diodes 100 may be advantageous in providing a compact projector 30 capable of producing a plurality of colors. Further, use of projectors 30 using the laser diodes 100 may provide multiple different images depending on the location of the transparency 14, screen 22 and/or display aid layer 34. For example, the laser diodes 100 may be pulsed at different intensities as the micro electric mirror 116 is rastered back and forth to create the image 38. Such an example may provide different data or images to different occupants of the vehicle 10 based on their location. Such examples may be advantageous in allowing different passengers of the vehicle 10 to view different data. For example, vehicle-related information may be displayed to a driver of the vehicle 10, while non-vehicle information (e.g., news, weather, social media, entertainment, private messages from a cell phone, etc.) is provided to front or rear passengers of the vehicle 10.

Use of the present disclosure may offer several advantages. First, use of the projector 30 in the rearview display 26, door 70 and/or headliner 74 offers a unique and concealed location from which to project the light to form the image 38. Second, the small size of the projector 30 allows for minimal manufacturing expenditure in incorporating the projector 30 into the vehicle 10. Third, use of laser examples of the projector 30 provides rich and true colors to the image 38. Fourth, use of the rearview display 26 as the location for the projector 30 allows a centralized location which will provide access to project the image anywhere on the windscreen 50.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims, as set forth below, are incorporated into and constitute part of this Detailed Description.

What is claimed is:

1. A vehicle projection display system, comprising:
a transparency;
a rearview display;
a display aid layer positioned on the transparency; and
a projector coupled to the rearview display and configured to project light onto the display aid layer, wherein the display aid layer is configured to scatter the light to form a projected image on the display aid layer.

2. The vehicle projection display system of claim 1, wherein the transparency is a windscreen.

3. The vehicle projection display system of claim 2, wherein the projector is configured to project the light onto a driver-side portion of the windscreen.

4. The vehicle projection display system of claim 2, wherein the projector is configured to project the light onto a passenger-side portion of the windscreen.

5. The vehicle projection display system of claim 1, wherein the transparency is a side window.

6. The vehicle projection display system of claim 1, further comprising:
an orientation sensor configured to detect the orientation of the rearview display within the vehicle.

7. The vehicle projection display system of claim 6, wherein the projector is configured to alter a direction of the emitted light in response to the orientation sensor detecting a change in orientation of the rearview display.

8. A vehicle projection display system, comprising:
a transparency;
a display aid layer positioned on a surface of the transparency; and
a projector positioned to project light onto the display aid layer, wherein the display aid layer is configured to scatter light to form a projected image on the display aid layer.

9. The vehicle projection display system of claim 8, wherein the projector is positioned above the transparency in a headliner.

10. The vehicle projection display system of claim 8, wherein the projector is positioned below the transparency in a door trim.

11. The vehicle projection display system of claim 8, wherein the projector is a laser projector.

12. The vehicle projection display system of claim 8, wherein the projector is a digital light processing projector.

13. The vehicle projection display system of claim 8, wherein a plurality of display aid layers are positioned on the transparency.

14. The vehicle projection display system of claim 8, wherein the display aid comprises a plurality of resonant nanoparticles.

15. The vehicle projection display system of claim 14, wherein the resonant nanoparticles comprise at least one of silver, gold, copper, aluminum, lithium and tantalum.

16. A vehicle projection display system, comprising:
a screen;
a display aid layer positioned on a surface of the screen, wherein the display aid layer comprises a plurality of resonant nanoparticles; and
a projector positioned to project laser light onto the display aid layer, wherein the display aid layer is configured to scatter the laser light to form a projected image on the display aid layer.

17. The vehicle projection display system of claim 16, wherein the screen is transparent.

18. The vehicle projection display system of claim 16, wherein the screen is translucent.

19. The vehicle projection display system of claim 16, wherein the screen is opaque.

20. The vehicle projection display system of claim 16, wherein the resonant nanoparticles comprise at least one of silver, gold, copper, aluminum, lithium and tantalum.
